(19) United States
(12) Patent Application Publication
(10) Pub. No.: US 2006/0118976 A1
(43) Pub. Date: Jun. 8, 2006

(54) Novelty air freshener

(76) Inventor: Russell Hoffman, Orlando, FL (US)

Correspondence Address: BEUSSE BROWNLEE WOLTER MORA & MAIRE, 390 N. ORANGE AVENUE, SUITE 2500, ORLANDO, FL, 32801, US

(21) Appl. No.: 11/233,215

(22) Filed: Sep. 22, 2005

Related U.S. Application Data
(63) Continuation of application No. 10/440,901, filed on May 19, 2003, now abandoned.

(51) Int. Cl. B01F 3/04

(52) U.S. Cl. 261/24; 261/DIG. 88

(57) ABSTRACT

Disclosed herein is a novel air freshener device that includes a novel secondary amusement feature that is actuated by moving air in the system.

### RELATED APPLICATIONS

This application is a continuation of U. S. Ser. No. 10/440,901 filed May 19, 2003.

### FIELD OF THE INVENTION:

This invention relates generally to an air freshener device having a secondary novelty feature that is powered by the fresh air exhausted out of the device.

### BACKGROUND OF THE INVENTION

As the atmosphere in general becomes more polluted and the general population becomes more aware of discomforts associated with dirty air, air filtration devices of all types and sizes have become more popular. One type of air filtration device provides a small fan for use in a smoky environment. These devices typically will include an electric fan contained in a small housing for tabletop use, with a filter through which the air is directed for removal of smoke and other such contaminants.

The object of conventional air freshening devices is to quietly perform their function while minimizing their intrusion in the room they are running. As a result, air fresheners do not add to the aesthetics of a room. At best, they simply occupy space blending into a room decor. But mostly, air fresheners are unattractive and detract from the decor.

### SUMMARY OF THE INVENTION

The present invention provides an air freshener apparatus that comprises a secondary amusement or entertainment feature. In an exemplified embodiment, the secondary amusement feature of the subject invention employs the air stream exhausted from the air freshener apparatus to power amusement functions. The amusement function may be tailored for children, but may be equally adapted for more mature entertainment. According to a specific embodiment, the secondary amusement feature is a car replica. The car replica is configured such that the air exhaust of the air freshener powers the wheels, causing the wheels to rotate. Other secondary amusement features will be apparent in light of the teachings herein. The subject invention utilizes an air stream to create an entertaining novelty air freshener apparatus that will bring life to the decor of a room. The subject invention realizes an opportunity to harness the air stream of conventional air fresheners or customized air freshening units to create a novelty that has heretofore not been realized.

### BRIEF DESCRIPTION OF THE DRAWINGS

FIG. 1 shows a perspective view of a car shaped embodiment of the subject invention.

FIG. 2 shows a perspective view of the disassembled embodiment shown in FIG. 1.

FIG. 3 shows a partial cross-sectional side view of the embodiment shown in FIG. 1.

FIG. 4 shows a bottom view of a portion of the embodiment shown in FIG. 1.

FIG. 5 shows a side/perspective view of a fish shaped embodiment of the subject invention.

### DETAILED DESCRIPTION OF THE INVENTION

There are numerous designs of air freshening devices that have been developed over the years. Such devices may be adapted to incorporate the novel features of the subject invention. Examples of known air filtering devices include, but are not limited to, those specifically disclosed in, and cited by reference in, U.S. Pat. Nos. 6,508,868; 4,268,285 and 3,936,284. According to the principles of the subject invention, the mechanical aspects of the air freshening devices, such as the fan, motor, and filter components are not critical. What is critical is the housing structure and the way the secondary entertainment feature is attached or integrated to the housing structure. The intake, and especially the exhaust port(s) must be configured properly in order to actuate the secondary entertainment feature.

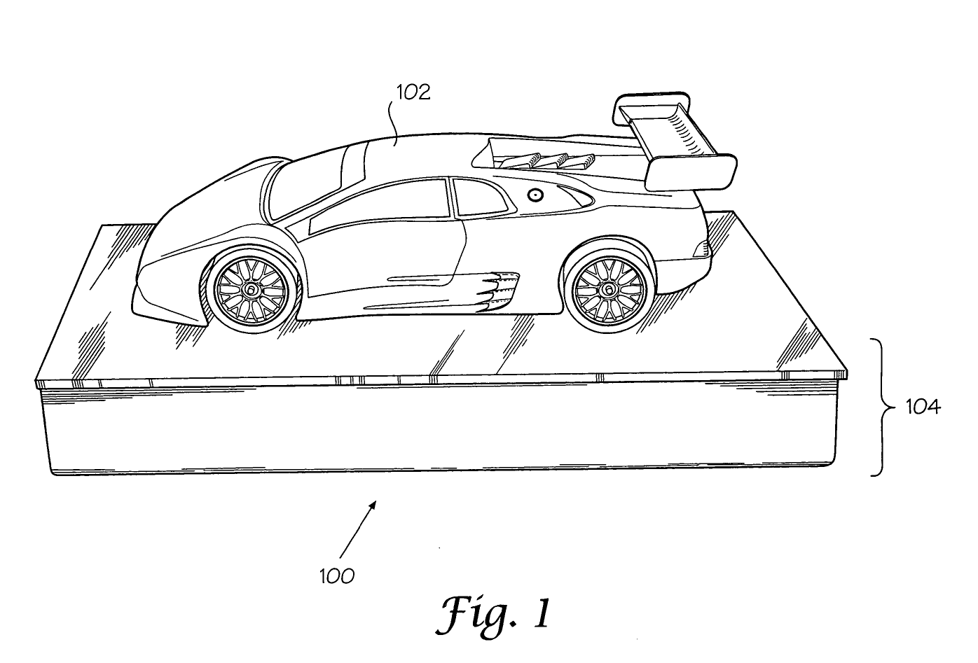

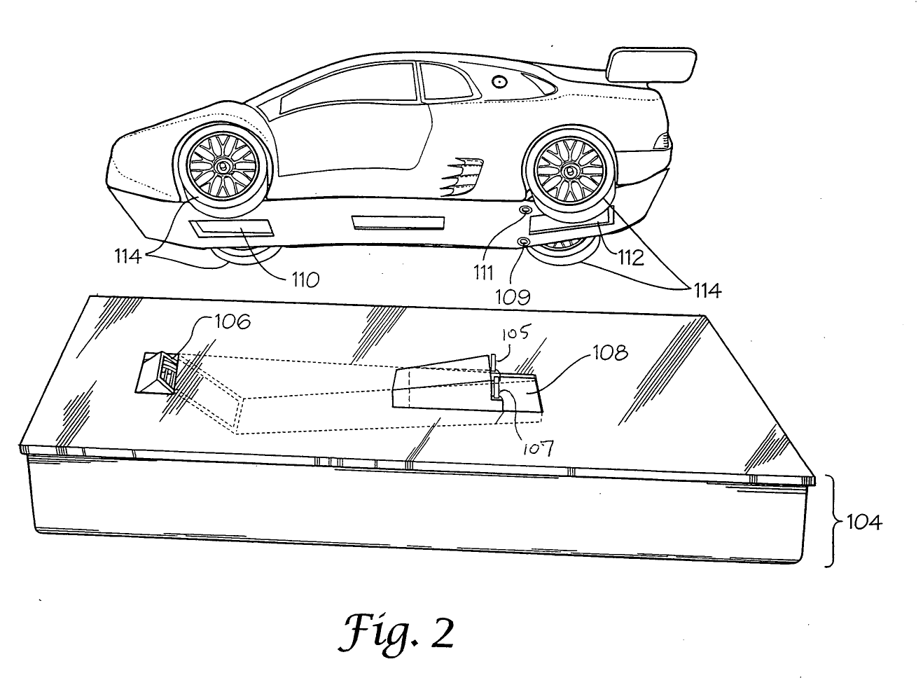

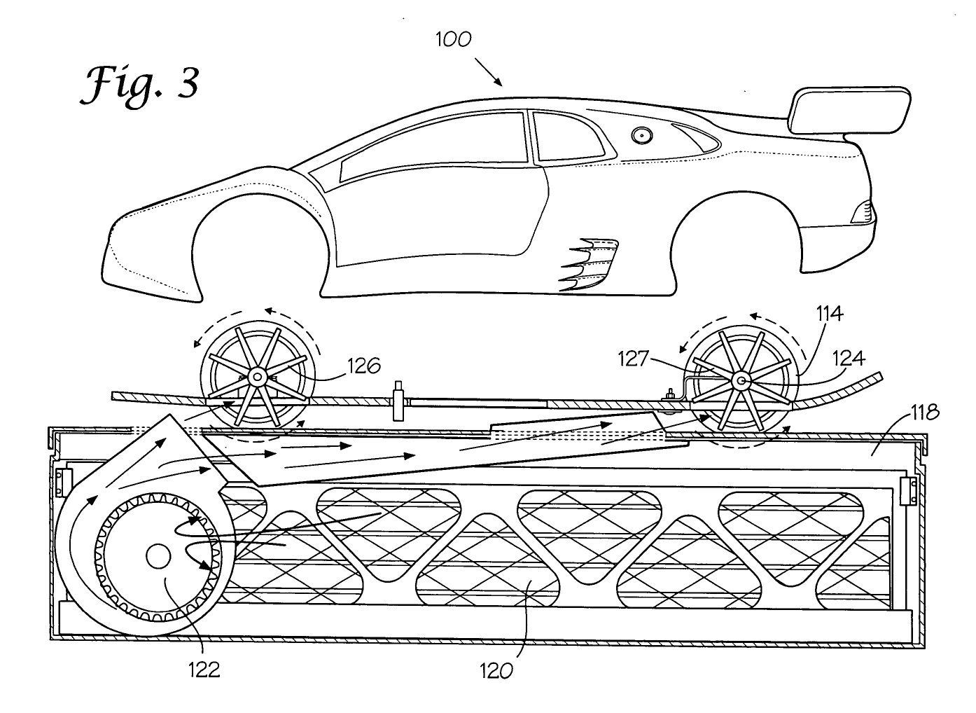

Turning to the drawings, FIG. 1 shows an embodiment of the subject novelty air freshening apparatus 100 that comprises a car replica 102 as a novel secondary feature which is conjoined to an air freshener housing 104. FIG. 2 shows that the air freshening housing 104 comprises two exhaust ports 106 and 108. Furthermore, the car replica 102 comprises two intake ports 110 and 112 which align with exhaust ports 106 and 108 when the car replica 102 is attached to the air freshening device 104. When the internal fan motor of the air freshening device is turned on, air is blown out of exhaust ports 106 and 108 and into intake ports 110 and 112. The car replica 102 is fastened onto the housing by posts 105, 107, which are positioned into holes 109, 111. Those skilled in the art will appreciate numerous other ways to fasten the novelty feature to the housing. The air stream causes the wheels 114 of the car replica 102 to spin, as shown in FIG. 3.

In an alternative embodiment, the device does not necessarily serve as an air freshener but acts as an air-powered amusement device. For example, a car replica or similar amusement feature is integrated or attached to a housing comprising a fan which blows air out at strategic locations. Such embodiment does not need an air filter or other air freshening means.

FIG. 3 shows a partial cross section of the embodiment 100 shown in FIGS. 1 and 2. The far wall 118 comprises intake slits (not seen) defined thereon and a filter 120 covering the intake slits. The filter 120 acts to remove pollutants and other undesirable contents in the air. The air is drawn into the air freshener device by the fan motor 122 and pushed out of the exhaust ports 106 and 108. The wheels 114 are connected onto a rod 124. Positioned on the rod 124 is a means 126, 127 for catching the air, thereby rotating the rod 124 and the wheels 114.

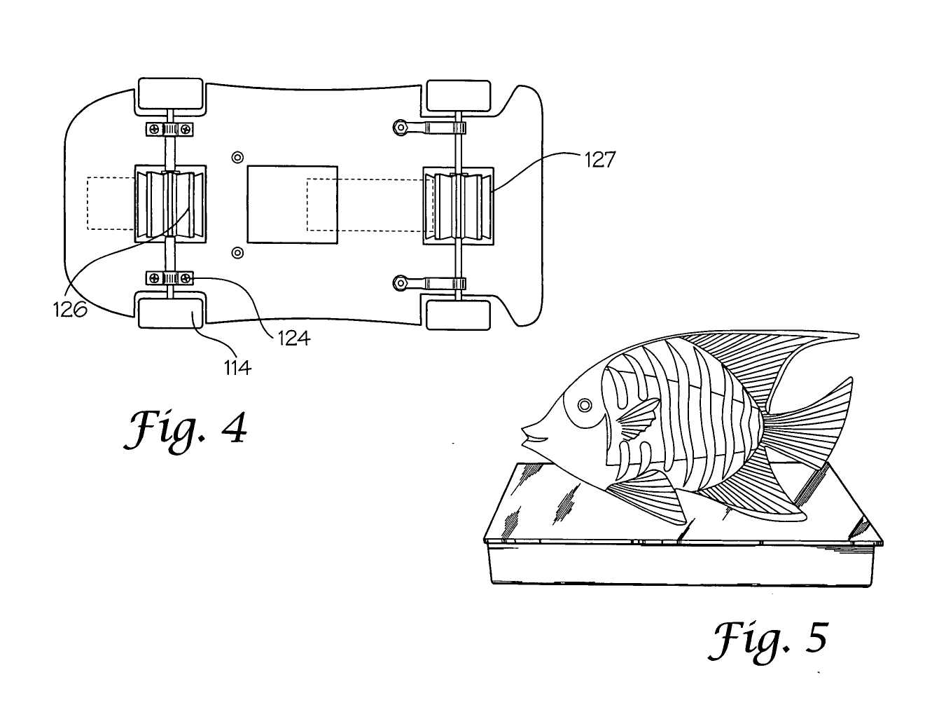

FIG. 4 shows a bottom view of the car replica 102. Shown are the wheels 114 and rod 124 and a means for catching air 126. FIG. 5 shows an alternative embodiment where the secondary novelty feature is a fish. As air is pushed into the fish, the fish flutters, simulating a swimming action. In view of the teachings herein, those skilled in the art will readily configure the fish to move employing gears, rods, tubes and other related mechanistic means. See, for example, U.S. Pat. Nos. 5,092,808; and 4,250,657, whose teachings are incorporated herein in their entirety to the extent not inconsistent with the teachings herein. Those skilled in the art will appreciate that a multitude of novelty features could be employed and conjoined with the air freshener device 104. Such novelty features include but are in no way limited to various animals (e.g. dog, cat, bird etc.), truck, helicopter, airplane, and train (with or without whistle). In an alternative embodiment, the secondary novelty feature is made of a fabric material. The fabric material may be a flag, or shaped like a car or other shape mentioned above. As air is pushed out of the exhaust ports, the fabric waves or moves providing an entertainment effect.

The terms “freshener” or “freshening”, as used herein refer to filtering out unwanted components in the air such as dust, smoke, malodorous substances, pollen, cat hair, cat dander, and other like components or pollutants. There are numerous filters known in the art that are adaptable in accordance with the teachings herein to filter one or more undesired components. Furthermore, these terms include release of deodorizers, fragrances, antibacterial substances, etc.

The secondary amusement features of the subject invention may be made of any suitably rigid and resilient material, including but not limited to metal, wood, fiberglass, plexiglass, glass, plastics, and graphite and/or carbon composites, and combinations thereof.

In an alternative embodiment, the subject invention relates to a light incorporated into the subject air freshener apparatus. In a preferred embodiment, an air freshener apparatus is incorporated into a pool table light, with or without a secondary amusement feature. For example, the secondary amusement feature may be incorporated into a light/air filtering device such as that disclosed in U.S. Pat. No. 5,443,625, whose teachings are incorporated by reference.

It is noted that the figures depicting this invention are merely representative of particular embodiments and are not meant to limit the range of possible configurations. Those skilled in the art will appreciate that the scope of this invention should be measured by the claims appended hereto, and not merely by the specific embodiments exemplified herein.

1. An air freshener apparatus comprising a housing, wherein said housing comprises a fan motor, at least one intake port, and at least one exhaust port; and a secondary amusement feature attached to or integrated with said housing, said secondary amusement feature configured to be actuated as air is propelled by said fan motor and wherein said secondary feature is in the shape of a vehicle, machine or animal and comprises at least one moving part, wherein said moving part moves as air is propelled by said fan motor.

2. The air freshener apparatus of claim 1, wherein said secondary feature is in the shape of a vehicle, machine or animal and comprises at least one moving part, wherein said moving part moves as air is propelled by said fan motor.

3. The air freshener apparatus of claim 2, wherein said secondary feature is a car replica comprising rotating wheels that spin as air is propelled by said fan motor.

4. The air freshener apparatus of claim 3, wherein said car replica is attached to said housing.

5. The air freshener apparatus of claim 3, wherein said secondary feature is integrated into said housing.

6. The air freshener apparatus of claim 1 wherein said secondary amusement feature is made of metal, wood, fiberglass, plexiglass, glass, plastics, or graphite and/or carbon composites, or combinations thereof.

7. An air freshening fixture comprising a housing comprising a fan and a freshening means, said housing configured to be mounted in spaced relationship to a ceiling of a room and in an elevated condition above an area where persons may congregate, comprising a light emitting means and comprising a secondary amusement feature attached to or integrated with said housing, wherein said secondary amusement feature comprises at least one moving part that is actuated by air expelled from said fan.

8. An air freshening fixture comprising a housing, said housing comprising a fan and a filter; a secondary amusement feature attached to or integrated with said housing, wherein said secondary amusement feature comprises at least one moving part that is actuated by air expelled from said fan; and a light emitting means.

9. The air freshening fixture of claim 8, wherein said fixture is attached to a post, wherein said post is attached to a base, whereby said fixture, post and base are configured such that said fixture is hoisted at a spaced relation relative to said base so that it may serve as a table lamp or floor lamp.
